(19) United States
(12) Patent Application Publication
(10) Pub. No.: US 2013/0147390 A1
(43) Pub. Date: Jun. 13, 2013

(54) FLASHLIGHT

(71) Applicant: Rainer Opolka, Solingen (DE)

(72) Inventor: Rainer Opolka, Solingen (DE)

(21) Appl. No.: 13/700,221

(22) PCT Filed: May 5, 2011
(86) PCT No.: PCT/DE2011/001029

§ 371 Date: Feb. 11, 2013

(30) Foreign Application Priority Data
Jul. 13, 2010 (DE) 10 2010 026 918.2

(51) Int. Cl. F21L 4/02

(52) U.S. Cl. CPC F21L 15/02
USPC 315/294; 315/291

(57) ABSTRACT

The present invention relates to a flashlight having a rotary switch for switching different brightness levels and/or luminous colors, which rotary switch has a battery cartridge arranged rotatably in a flashlight housing and having spring-mounted electrical contacts arranged at the end, which electrical contacts are each connected to an electrical contact face or an electrical contact zone of a contact plate. In order to provide a switchover option for a flashlight with different switching steps that has a simple design, is light and can be operated reliably, the invention proposes that the battery cartridge is held securely in the flashlight housing by a fixing sleeve and that the battery cartridge is rotated in the flashlight housing by a rotary button that passes longitudinally axially through the fixing sleeve.

The invention relates to a flashlight having a rotary switch for switching different brightness levels and/or luminous colors, which rotary switch has a battery cartridge arranged rotatably in a flashlight housing and having spring-mounted electrical contacts arranged at the end, which electrical contacts are each connected to an electrical contact face or an electrical contact zone of a contact plate.

In recent years, conventional flashlights with an incandescent bulb have increasingly been replaced by flashlights having light-emitting diodes (LEDs). The advantage of an LED consists in particular in the lower consumption of electricity in comparison with the incandescent bulb, the impact and shock resistance and a much longer life. This is due not least to the fact that, in contrast to an incandescent bulb, the greater part of the energy supplied is converted directly into light generation, and not into heat.

Meanwhile, different light-emitting diodes are also known which have different brightnesses and/or can output light in different colors. In addition, LED chips on a contact plate, so-called chips on boards, are also known, even in variants where different LEDs are arranged on a mount.

In order to switch over the light-emitting diode or light-emitting diodes to a greater brightness or to a different color mix, it is necessary to activate in each case different circuits with different voltages, for which purpose mechanical step switches are known that close different or else additional contacts, depending on the switching step. The disadvantage of such step switches consists in their relatively high level of susceptibility to wear and the sometimes notched guides, in which it is not possible to rule out the possibility of jamming. Depending on the quality of the compression spring used and of the detachable latching elements, undesired faulty switching operations likewise cannot be ruled out.

In addition to such step switches, rotary switches are also known. For example, WO 00/45086 describes a tubular flashlight with a light source at in each case one end of the flashlight. The flashlight comprises two parts that are rotatable with respect to one another. One part of the flashlight is connected to a battery cartridge, with a segmented contact plate being fastened to the end side of the battery cartridge, the segmented contact plate bearing against fixedly mounted electrical contacts of the other part. By rotation of the battery cartridge, the electrical contacts can be connected to different contact faces and can therefore close different circuits.

One disadvantage with the described construction consists in that the flashlight parts are only plugged together and can therefore be withdrawn easily from one another, whereby they will lose their functionality.

An object of the present invention therefore consists in providing a switchover option for a flashlight with different switching steps that has a simple design, is light and can be operated reliably. In particular, such a flashlight should have a robust configuration and should also function reliably during robust use.

This object is achieved by the flashlight as claimed in claim 1, in accordance with which the invention provides that the battery cartridge is held securely in the flashlight housing by a fixing sleeve and can be rotated in the flashlight housing by a rotary button that passes longitudinally axially through the fixing sleeve. Such a flashlight has a simple and at the same time robust configuration, despite having a rotary switch.

Advantageous developments will be described below and in the dependent claims.

A first preferred embodiment of the invention provides that the contact plate has, on one side, a centrally arranged electrical contact face and a plurality of electrical contact zones spaced radially apart from the contact face. However, other configurations are also conceivable. For example, the electrical contact face could be configured in the form of a ring or part of a ring, in which case it is only necessary to take care to ensure that the corresponding electrical contact is arranged in such a way that it remains in a bearing arrangement with the contact face on rotation of the battery cartridge. At least one LED is preferably arranged on the other side of the contact plate.

The basic concept of the present invention relates to a flashlight with different switching states. In order to make this possible, the contact zones are connected to different electrical resistors or different LEDs, with the result that the choice of the circuit-closing contact zone and the function of the flashlight can be fixed. In order that no current flow is produced between the individual contact zones, the electrical contact faces and the electrical contact zones are isolated from one another by insulating webs. In accordance with a preferred embodiment of the invention, one spring-mounted electrical contact is connected electrically so as to produce touching contact to the centrally arranged contact face and the other electrical contact is connected to one of the radially spaced-apart contact zones. However, the specific position and shape of the contact face and the contact zones is not of critical importance ultimately. Instead, the important factor is that the respective contacts are connected to the contact face or the desired contact zone even during rotation of the battery cartridge.

In order to impart the desired stability to the flashlight in the assembled state in order that it remains reliably functional even during robust use, the battery cartridge is held securely in the flashlight housing. Preferably, for this purpose, it has a rear ring-shaped stop face and a threaded section, wherein the fixing sleeve has corresponding stop faces and a threaded section, with which it is connected to the flashlight housing. Finally, the rotary button is connected to the battery cartridge via a threaded section, with the result that the battery cartridge can be rotated in the flashlight housing via the threaded section. In the installed state, the rotary button passes longitudinally axially through the fixing sleeve.

A further preferred configuration of the present invention provides that the battery cartridge has a pressure-operated switch that is operatively connected to a pushbutton arranged in the rotary button. This additional pressure-operated switch makes it possible for the user to select the desired switching function of the flashlight in the switched-off state by rotating the battery cartridge and to switch on this function via the pressure-operated switch. Furthermore, the provision of the pressure-operated switch makes it possible to prevent the flashlight from switching on as a result of unintentional rotation of the rotary button, which can easily take place, for example, in the case of transport in a rucksack or a bag.

Further preferred embodiments and specific configurations of the invention will be explained below with reference to the figures, in which:

FIG. 1 shows a side view of a flashlight,

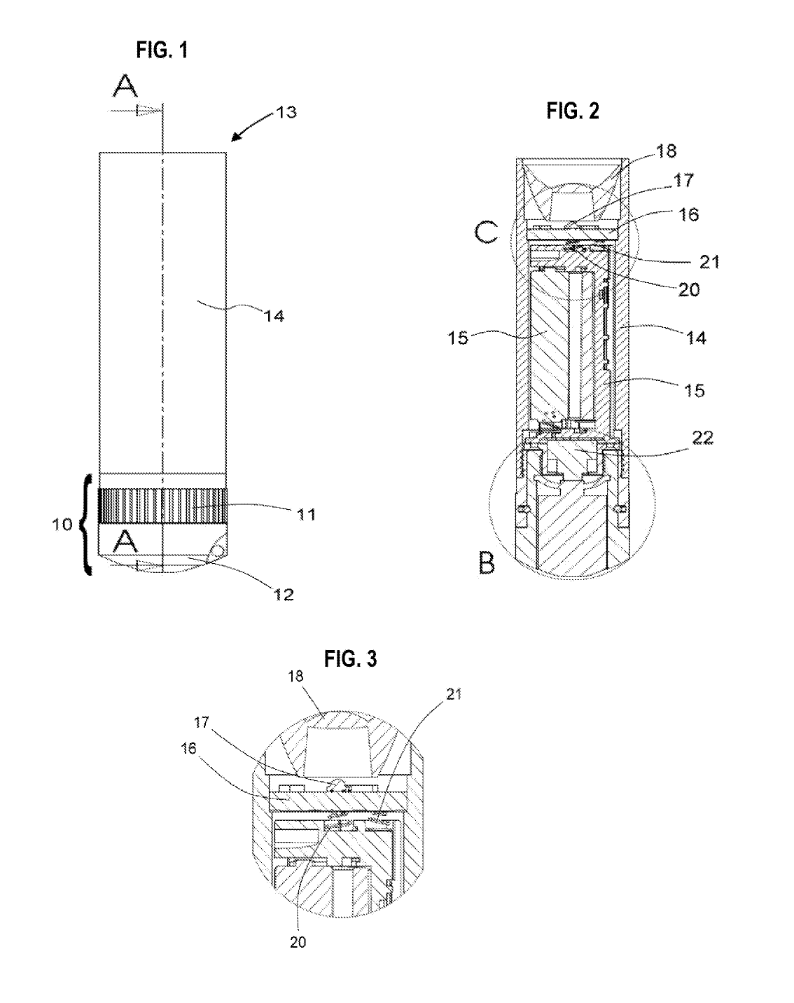

FIG. 2 shows a longitudinal sectional view of the flashlight shown in FIG. 1 along the line A-A,

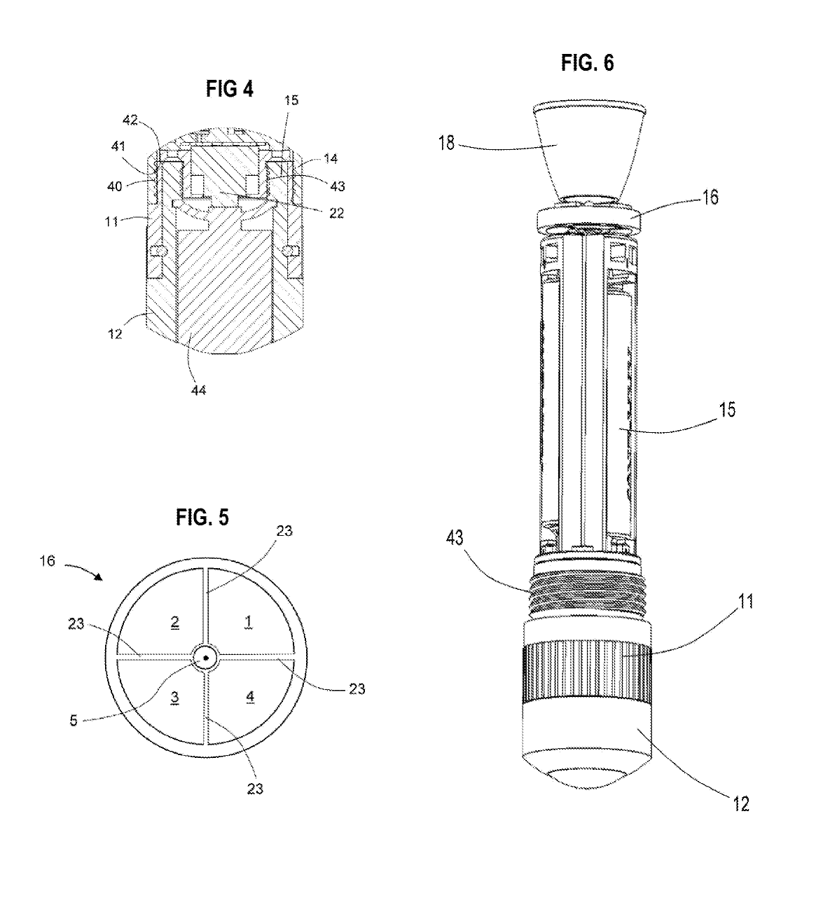

FIGS. 3 and 4 show detail views of the details C and B in FIG. 2,

FIG. 5 shows the underside of a disk-shaped contact plate with four contact zones and one contact face, and

FIG. 6 shows a schematic view of a lamp head with an auxiliary optical element, a chip on board and a battery cartridge held on an end cap.

The flashlight illustrated in the FIGS. has a cylindrical shape with an end cap 10 that can be screwed, is fixed detachably at the end and is formed from a fixing sleeve 11 and a rotary button 12, and with an end 13 which is open at the front end and is in the form of a light exit surface. At least one battery or one battery stack or one battery cartridge 15 that accommodates a plurality of series-connected batteries, is arranged in the flashlight housing 14. In addition, the flashlight has a contact plate 16 with at least one LED 17. When using a single LED 17, different colors and/or different brightnesses can be emitted depending on the voltage drop across the LED 17.

In addition, the flashlight has an auxiliary optical element 18 that is in the form of a reflector lens, wherein radiation emitted in the center is incident on the inner focusing lens part and is focused there so as to produce parallel light, whereas the laterally emitted rays are incident on a conical surface and an outer reflector surface, from where they are likewise emitted in the direction of the open end 13.

According to the invention, the flashlight has a rotary switch that in the present case is formed by the contact plate 16, the battery cartridge 15 and the rotary button 12. In the case illustrated, the battery cartridge 15 has a first central spring contact 20 that is electrically connected to the central contact face 5, and a decentralized contact spring 21 that, together with the rotatable battery cartridge 15, sweeps over different electrical contact zones 1, 2, 3, 4 beneath the contact plate 16. When using a battery stack without a battery cartridge 15 or when using a single battery, the central contact can also be provided by the positive terminal of the battery. The contact spring can, as illustrated in principle in FIG. 5, make contact with one of the contact zones 1, 2, 3, 4, wherein each contact zone 1, 2, 3, 4 provides different switching options. In each case, insulating webs 3 are arranged between the contact zones 1 to 4 and prevent faulty switching operations as a result of the contact spring 21 simultaneously touching two contact zones.

The variation of the switching options is as extensive as desired and is only limited by the fact that the contact spring 21 needs to rest securely on one of the contact zones 1, 2, 3, 4 produced in a defined switching state. By using additional elements or further control circuits, blinking functions can also be realized in addition to different diodes or diode groups and different voltages being switched on.

In addition, the flashlight illustrated has a pressure-operated switch 22, with the result that the desired switching function can also be selected in the switched-off state.

The secure holding of the battery cartridge 15 within the flashlight housing 14 is illustrated in the detail view shown in FIG. 4. In this regard, the flashlight housing 14 has a threaded section 40, via which the fixing sleeve 11 is fastened. The fixing sleeve 11 has a bearing face 41 which is in a bearing arrangement with a bearing face 42 of the battery cartridge 15 and holds the battery cartridge in the flashlight housing 14. Furthermore, the battery cartridge 15 is connected to the rotary button 12 via a threaded section 43, which rotary button passes longitudinal axially through the fixing sleeve 11. In the illustrated case, the pushbutton 44, which is connected to the pressure-operated switch 22 of the battery cartridge 15, is located within the rotary button 12.

1. A flashlight having a rotary switch for switching different brightness levels and/or luminous colors, which rotary switch has a battery cartridge arranged rotatably in a flashlight housing and having spring-mounted electrical contacts arranged at the end, which electrical contacts are each connected to an electrical contact face or an electrical contact zone of a contact plate, wherein
the battery cartridge is held securely in the flashlight housing by a fixing sleeve and can be rotated in the flashlight housing by a rotary button that passes longitudinally axially through the fixing sleeve.

2. The flashlight as claimed in claim 1, wherein the contact plate has, on one side, a centrally arranged electrical contact face and a plurality of electrical contact zones spaced radially apart from the contact face.

3. The flashlight as claimed in claim 2, wherein at least one LED is arranged on the other side of the contact plate.

4. The flashlight as claimed in claim 1, wherein the electrical contact face and the electrical contact zones are isolated from one another by insulating webs.

5. The flashlight as claimed in claim 1, wherein one spring-mounted electrical contact is electrically connected to the centrally arranged contact face and the other electrical contact is connected to one of the radially spaced-apart contact zones.

5. The flashlight as claimed in claim 1, wherein the battery cartridge has a ring-shaped stop face and a threaded section at the rear end.

6. The flashlight as claimed in claim 1, wherein the fixing sleeve can be connected to the flashlight housing via a threaded section and has a bearing face that is designed to bear against the battery cartridge and to hold the battery cartridge securely.

7. The flashlight as claimed in claim 1, wherein the rotary button is connected to the battery cartridge via a threaded section.

8. The flashlight as claimed in claim 1, wherein the battery cartridge has a pressure-operated switch that is operatively connected to a pushbutton arranged in the rotary button.
